(19) United States
(12) Patent Application Publication
(10) Pub. No.: US 2023/0301324 A1
(43) Pub. Date: Sep. 28, 2023

(54) METHOD FOR SEPARATION OF FAT AND PROTEIN IN EGG AND EGG PRODUCTS

(71) Applicant: ISONOVA TECHNOLOGIES LLC, Springfield, MO (US)

(72) Inventors: Andressa Gusmao, Valley Park, MO (US); Ingmar Middelbos, Chesterfield, MO (US); Joel Bartley, Florissant, MO (US)

(21) Appl. No.: 18/124,883

(22) Filed: Mar. 22, 2023

Related U.S. Application Data
(60) Provisional application No. 63/322,436, filed on Mar. 22, 2022.

(51) Int. Cl. A23J 1/08; A23K 10/20; A23K 20/147; A23K 10/14

(52) U.S. Cl. CPC A23J 1/08; A23K 10/20; A23K 20/147; A23K 10/14

(57) ABSTRACT

A method for separating protein and fat from egg or egg products. According to the disclosed methods, proteins and fat are separated from a mixture containing egg whites and yolk.

### RELATED APPLICATION

This application claims priority to U.S. Provisional Application 63/322,436 filed on Mar. 22, 2022, the content of which is incorporated herein by reference in its entirety for all purposes.

### BACKGROUND

### 1. Field of the Invention

This disclosure relates to a process for preparing high protein composition from egg products. More particularly, the disclosure relates to methods for separating protein and fat in egg and egg products.

### 2. Description of Related Art

Eggs are a complex blend of several components. The most abundant components in eggs are proteins and fat. The proteins and fat in eggs together can act as an emulsifier. Whole broken eggs used in the industry are usually in a state of a homogeneous emulsion. This emulsion is relatively stable and it is difficult to separate the egg proteins from the lipids.

### SUMMARY

The instrumentalities disclosed herein overcome the problems outlined above by providing a method for separating protein and fat in egg and egg products.

In certain embodiments, a process is disclosed for separating protein and fat in a starting material prepared or derived from eggs, comprising (a) adjusting the pH of starting material to a pH between 5 and 7, (b) adding an effective amount of lipase to the starting material to form a mixture, (c) incubating the mixture of step (b) at a temperature between 37° C. and 45° C. for a time period at least 10 min to obtain a digested mixture, (d) subjecting the digested mixture to a centrifugal separation, forming at least two phases, said at least two phases comprising a protein phase and a lipid phase, and (e) collecting the protein phase and the lipid phase separately, wherein the starting material comprises more than 0.2% egg yolk by weight of total solids before it is subject to the process of step (a).

In certain embodiments, step (b) above is performed before step (a), or in other words, the lipase is added to the egg white and yolk mixture and then the pH of the mixture is adjusted to a pH between 5 and 6.5, or between 6 and 6.5, or around 6.5 by adding one or more pH adjusting agent, followed by step (c) above.

In one aspect, the starting material may be prepared from regular eggs. In another aspect, the starting material may be prepared from eggs graded as not suitable for consumption by human, for example, eggs that have been subject to hatching process but fail to hatch. In another aspect, the starting material may be prepared from liquid egg from egg-breaking plant, which typically contains more than 0.2% yolk content.

In certain embodiments, the starting material may contain more than 1%, 2%, 5%, 10%, 20% or 30% egg yolk by weight of total solids prior to step (a). In certain embodiments, the egg white and egg yolk in the starting material have been mixed and form an emulsion prior to being subject to step (a). In the emulsion state, it is difficult to separate the egg white and egg yolk by using mechanical separation only.

In certain embodiments, the pH of the starting material may be measured prior to step (a) above. In one aspect, the pH of the starting material has a pH between 7 and 9, or between 7 and 8. In another aspect, in step (a), the starting material is adjusted to a pH between 5 and 6.5, or between 6 and 6.5, or about 6 or about 6.5 by adding one or more pH adjusting agent. In certain embodiments, no pH adjustment is performed between step (c) and step (d) above.

In certain embodiments, the lipase may be a microbial lipase isolated from various fungi. Examples of the microbial sources include but are not limited to Mucor javanicus; Rhizopus oryzae; Candida cylindracea. In one aspect, the lipase may be a commercially available enzyme with an optimal pH at 7 or higher. In another aspect, the lipase has an optimal pH at 7 or higher but is used during step (b) at a pH between 5 and 6.5, or between 6 and 6.5, or about 6 or about 6.5. In certain embodiments, only one lipase enzyme is used, no co-lipase (or second lipase) is needed for the instant process.

In certain embodiments, the lipase is inactivated after step (c). In some other embodiments, the lipase is not inactivated after step (c).

In certain embodiments, the digested mixture forms three phases after the centrifugation step (d): a top phase, a middle phase and a bottom phase, wherein the top phase contains low-density fat, the middle phase contains proteins and the bottom phase contains a substance similar to egg yolk and some egg impurities.

In some other embodiments, after the digested mixture is subject to the centrifugation step (d), two major layers are formed: one layer containing primarily protein, the other layer containing primarily fat and some egg impurities.

In certain embodiments, food-grade pH adjusting agent or enzyme is used in the disclosed process. In some other embodiments, non-food-grade pH adjusting agent or enzyme is used, wherein these non-food-grade pH adjusting agent or enzyme is not rated suitable for human consumption but is rated suitable for animal feed.

In certain embodiments, the amount of lipase used in step (b) is 0.01% to 0.3%, or 0.06% to 0.3%, or 0.1% to 0.3% by weight of the total starting material. In one aspect, the amount of lipase used in step (b) is higher than 0.05% by weight of the total starting material.

In certain embodiments, the incubation time in step (b) is at least 10 min. In certain embodiments, the incubation time in step (b) is 10-60 min, or 10-120 min, or longer. In one aspect, the pH and/or temperature of the material are monitored during step (c). In another aspect, the pH is further adjusted during step (c).

In certain embodiments, the starting material is not subject to a fermentation process before or after the lipase is added. In some other embodiments, the starting material is subject to a fermentation process before or after the lipase is added to decrease the sugar content in the material.

In certain embodiments, the protein phase obtained in step (e) comprises less than 2%, or less than 1% of fat by weight of total solids.

In certain embodiments, the protein phase obtained in step (e) comprises about 50% to 99%, or about 55% to 90% protein by weight of total solids.

In certain embodiments, the fat (lipid) phase obtained in step (e) comprises about 50% to 99%, or about 55% to 90% fat by weight of total solids and less than 5%, or less than 1% protein by weight of total solids. In certain embodiments, the fat (lipid) phase obtained in step (e) comprises less than less than 5%, or less than 1% egg impurities by weight of total solids. The fat phase may be collected for different commercial applications.

In certain embodiments, the protein phase obtained in step (e) may be added to animal feed to produce an enhanced animal feed comprising at least 0.1%, or at least 0.5%, or at least 1%, or at least 2% egg protein.

### DETAILED DESCRIPTION

This disclosure provides a process for preparing high protein composition from egg products. More particularly, the disclosure relates to methods for separating protein and fat in egg and egg products.

It is commonly known that egg whites are rich in proteins while egg yolk is rich in lipids. Typically, egg whites have a pH that is slightly basic, between 7.5 and 9, while egg yolk usually is more acidic, having a pH between 6-7. Mixtures of egg whites and yolk tend to form an emulsion, which makes it very difficult to separate the egg whites and yolk fractions. It is disclosed here that when lipase is used at a slightly acidic pH (for example, 5-7) to digest the lipid in a mixture containing egg whites and yolk, the resultant digested lipid components are relatively easier to separate from the protein fraction.

The disclosed process may include the following steps: (a) adjusting the pH of starting material to a pH between 5 and 7, (b) adding an effective amount of lipase to the starting material to form a mixture, (c) incubating the mixture of step (b) at a temperature between 37° C. and 45° C. for a time period at least 10 min to obtain a digested mixture, (d) subjecting the digested mixture to a centrifugal separation, forming at least two phases, said at least two phases comprising a protein phase and a lipid phase, and (e) collecting the protein phase and the lipid phase separately, wherein the starting material comprises more than 0.2% egg yolk by weight of total solids before it is subject to the process of step (a).

The term “starting material” refers to a mixture containing egg white and egg yolk. For purpose of this disclosure, the starting material typically contains at least 60% egg white by volume or about 50% by weight of total solids, and the starting material also typically contains more than 0.2% egg yolk by weight of total solids. In certain embodiments, the starting material contains more than 1%, 2%, 5%, 10%, 20% or 30% egg yolk by weight of total solids.

The term “egg” refers to poultry eggs.

By way of example, several embodiments of the disclosed processes are described below:

Item 1. A process for separating protein and fat in a starting material prepared or derived from eggs, comprising
(a) adjusting the pH of starting material to a pH between 5 and 7,
(b) adding an effective amount of lipase to the pH-adjusted starting material of step (a) to form a mixture,
(c) incubating the mixture of step (b) at a temperature between 37° C. and 45° C. for a time period at least 10 min to obtain a digested mixture,
(d) subjecting the digested mixture to a centrifugal separation, forming at least two phases, said at least two phases comprising a protein phase and a lipid phase, and
(e) collecting the protein phase and the lipid phase separately,
wherein said starting material prior to step (a) comprises more than 0.2% egg yolk by weight of total solids.

Item 2. The process of Item 1, wherein the starting material is prepared from eggs graded as not suitable for consumption by human.

Item 3. The process of any preceding items, wherein the starting material is prepared from unhatched eggs that have been subject to a hatching process.

Item 4. The process of any preceding items, wherein said starting material prior to step (a) comprises more than 1% egg yolk by weight of total solids.

Item 5. The process of any preceding items, wherein the egg white and egg yolk in the starting material have been mixed and form an emulsion prior to being subject to step (a).

Item 6. The process of any preceding items, wherein the digested mixture forms three phases after the centrifugal separation: a top phase, a middle phase and a bottom phase, the top phase comprising low-density fat, the middle phase comprising proteins and the bottom phase comprising a substance similar to egg yolk and egg impurities.

Item 7. The process of any preceding items, wherein food grade agent is used for adjusting the pH in step (a).

Item 8. The process of any preceding items, wherein the amount of lipase used in step (b) is 0.01% to 0.3% by weight of total starting material.

Item 9. The process of any preceding items, wherein the starting material is not subject to a fermentation process before or after the lipase is added.

Item 10. The process of any preceding items, wherein the protein phase obtained in step (e) comprises less than 2% of fat by weight of total solids.

Item 11. The process of any preceding items, wherein the protein phase obtained at step (e) is added to animal feed to produce an enhanced animal feed comprising at least 0.5% egg protein.

Item 12. The process of any preceding items, wherein the pH is about 6-6.5 in step (b).

It is to be noted that, as used in this specification and the claims, the singular forms “a,” “an,” and “the” include plural referents unless the context clearly dictates otherwise. Thus, for example, reference to “a device” may include reference to one device, as well as two or more devices, unless the context clearly limits the reference to one device.

The terms “between” and “at least” as used herein are inclusive. For example, a range of “between 5 and 10” means any amount equal to or greater than 5 but equal to or smaller than 10.

Unless otherwise specified, the percentage of certain component in a composition is by weight. Various commercially available products may have been described or used in this disclosure. It is to be recognized that these products are cited for purpose of illustration only. Certain physical and/or chemical properties and composition of the products may be modified without departing from the spirit of the present disclosure. One of ordinary skill in the art may appreciate that under certain circumstances, it may be more desirable or more convenient to alter the physical and/or chemical characteristics or composition of one or more of these products in order to achieve the same or similar objectives as taught by this disclosure.

### EXAMPLES

The following examples are provided to illustrate the present invention, but are not intended to be limiting. The reagents, materials and instruments are presented as typical components, and various substitutions or modifications may be made in view of the foregoing disclosure by one of skills in the art without departing from the principle and spirit of the present invention.

### Example 1

The goal for these experiments is to separate fat and protein from whole liquid egg (a mix of egg yolk and whites), which is a very stable liquid mixture. The raw material was whole egg which was approximately 66% egg whites and 33% yolk by volume. All raw material was from whole eggs that are inedible for human. Several trials were performed with different enzymes, pH and temperatures. 4 different enzyme: ENZECO® Esterase/Lipase 6-8.5, ENZECO® LIPASE RO 20 6, Lipomod 34P, ENZECO® LIPASE RO Concentrate 7 were tested. Briefly, the pH of the mix of egg yolk and whites was measured and when the pH was outside the range of 5-6.5, a pH adjusting agent was added to adjust the pH to 5-6.5. The enzyme was then added to the mix of egg yolk and whites and incubated at different temperatures and pH. Based on these tests, the optimal pH for all 3 enzymes was between 5-6.5 and optimal temperature was 37-45° C. Best usage rate was from 0.04 to 0.3%.

After the digestion was done, the digested mixture was subject to centrifugation to separate the phases containing fat and protein. When a centrifuge was used, 3 layers separation was observed. First phase contained basically fat, middle one containing water and protein and bottom one contained fat and egg impurities. Each phase would generate a product to be used in feed industry (e.g., protein concentrate product, fat concentrate product). Success in the trials was measured by how much separation was achieved in each phase and how close those ratios are to egg whites and yolks.

In order to determine the optimal pH for the digestion, the pH of several batches of the starting materials was adjusted and then mixed with the same lipase, ENZECO® Esterase/Lipase. As shown in Table 1, at lower pH, e.g., 6.5 or 6, the Fat extraction percentage and liquid protein DB were both substantially higher than at pH 7 or 8. Fat extraction is calculated by (fat separated in the bottom phase)/(fat in the initial raw material-egg)×100%. A CEM Oracle NMR equipment was used to measure fat content. The liquid protein DB (dry basis) in Table 1 is based on protein content in the middle phase. The protein was analyzed in LECO by using a combustion furnace to analyze protein content. The solids content was analyzed using a CEM Smart 6 microwave moisture analyzer.

TABLE 1
Comparison of protein/fat separation at different lipase digestion pH

| | | | | | | | Liquid |
|---|---|---|---|---|---|---|---|
| | | | Temperature | Usage | Pellet | Fat | Protein |
| Date | Enzyme | pH | (° C.) | rate (%) | Fraction (%) | Extraction (%) | DB (%) |
| Aug. 24, 2021 | ENZECO ® Esterase/Lipase | 8 | ~38-41 | 0.1 | 1.82 | — | |
| Sep. 2, 2021 | ENZECO ® Esterase/Lipase | 7 | ~38-41 | 0.1 | 5.63 | 20.49 | 56.68 |
| Aug. 18, 2021 | ENZECO ® Esterase/Lipase | 6.5 | ~38-41 | 0.1 | 15.94 | 75.07 | 71.14 |
| Dec. 14, 2021 | ENZECO ® Esterase/Lipase | 6 | ~38-41 | 0.1 | 12.40 | 65.56 | 71.55 |

We claim:

1. A process for separating protein and fat in a starting material prepared or derived from eggs, comprising
(a) adjusting the pH of starting material to a pH between 5 and 7,
(b) adding an effective amount of lipase to the pH-adjusted starting material of step (a) to form a mixture,
(c) incubating the mixture of step (b) at a temperature between 37° C. and 45° C. for a time period at least 10 min to obtain a digested mixture,
(d) subjecting the digested mixture to a centrifugal separation, forming at least two phases, said at least two phases comprising a protein phase and a lipid phase, and
(e) collecting the protein phase and the lipid phase separately,
wherein said starting material prior to step (a) comprises more than 0.2% egg yolk by weight of total solids.

2. The process of claim 1, wherein the starting material is prepared from eggs graded as not suitable for consumption by human.

3. The process of claim 1, wherein the starting material is prepared from unhatched eggs that have been subject to a hatching process or from liquid egg from an egg-breaking plant.

4. The process of claim 1, wherein said starting material prior to step (a) comprises more than 1% egg yolk by weight of total solids.

5. The process of claim 1, wherein the egg white and egg yolk in the starting material have been mixed and form an emulsion prior to being subject to step (a).

6. The process of claim 1, wherein the digested mixture forms three phases after the centrifugal separation: a top phase, a middle phase and a bottom phase, the top phase comprising low-density fat, the middle phase comprising more than 70% proteins by weight of total solids and the bottom phase comprising a substance similar to egg yolk and egg impurities.

7. The process of claim 1, wherein food grade agent is used for adjusting the pH in step (a).

8. The process of claim 1, wherein the amount of lipase used in step (b) is 0.01% to 0.3% by weight of total starting material.

9. The process of claim 1, wherein the starting material is not subject to a fermentation process before or after the lipase is added.

10. The process of claim 1, wherein the protein phase obtained in step (e) comprises less than 2% of fat by weight of total solids.

11. The process of claim 1, wherein the protein phase obtained at step (e) is added to animal feed to produce an enhanced animal feed comprising at least 0.1% egg protein.

12. The process of claim 1, wherein the pH is about 6-6.5 in step (b).
